(19) United States
(12) Patent Application Publication
(10) Pub. No.: US 2022/0049496 A1
(43) Pub. Date: Feb. 17, 2022

(54) SYSTEMS AND METHODS FOR THERMAL BREAKING OF A PREFABRICATED PANEL

(71) Applicant: NEXII BUILDING SOLUTIONS INC., Vancouver (CA)

(72) Inventors: Michael Anthony DOMBOWSKY, Moose Jaw (CA); Benedict John DOMBOWSKY, Moose Jaw (CA); Mark Benedict DOMBOWSKY, Moose Jaw (CA); Braden Louis DOMBOWSKY, West Kelowna (CA)

(21) Appl. No.: 17/402,372

(22) Filed: Aug. 13, 2021

Related U.S. Application Data
(60) Provisional application No. 63/065,362, filed on Aug. 13, 2020.

(51) Int. Cl. E04C 2/288; B32B 7/022; B32B 13/04; B32B 13/12; B32B 13/10

(52) U.S. Cl. CPC E04C 2/2885; B32B 7/022; E04B 1/14; B32B 13/12; B32B 13/10; B32B 13/045

(57) ABSTRACT

Example embodiments of the described technology provide a prefabricated building panel. The prefabricated building panel may comprise an insulative core having first and second opposing faces. The prefabricated building panel may also comprise a cementitious layer covering at least one of the first and second opposing faces of the insulative core. The prefabricated building panel may also comprise an insulative casing. The insulative casing may comprise an insulative material. The casing may at least partially surround at least one edge surface of the panel.

### CROSS-REFERENCE TO RELATED APPLICATIONS

This application claims the benefit under 35 U.S.C. § 119 of U.S. application No. 63/065362 filed 13 Aug. 2020 and entitled SYSTEMS AND METHODS FOR THERMAL BREAKING OF A PREFABRICATED PANEL which is hereby incorporated herein by reference for all purposes.

### FIELD

This invention relates to building panels and in particular cementitious prefabricated building panels such as Concrete Structural Insulated Panels. Example embodiments provide systems and methods for achieving desired performance characteristics.

### BACKGROUND

Constructing a building is typically an extensive project involving significant amounts of time and/or resources (labour, energy, materials, etc.). Moreover, the carbon footprint of a building built using existing systems and methods can be large.

Reducing the amount of time and/or resources required to construct a building can be desirable. Reducing the carbon footprint of a building can also be desirable. With more environmentally stringent building codes being passed regularly, reducing the amount of resources used to construct a building and the carbon footprint of the building is increasingly becoming a requirement to be in compliance with new building codes.

One way the amount of time and/or resources required can be reduced is by constructing the building using prefabricated panels. Existing prefabricated panels however are heavy, cannot provide the required performance characteristics, etc. Additionally, existing prefabricated panels may be difficult to maneuver into place and to couple together.

There remains a need for practical and cost effective ways to construct prefabricated building panels using systems and methods that improve on existing technologies.

### SUMMARY

This invention has a number of aspects. These include, without limitation:
systems and methods for increasing a thermal break of a prefabricated panel;
prefabricated panels with an insulative casing;
methods for constructing a prefabricated panel.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 is a schematic cutaway perspective view of a prefabricated panel according to an example embodiment of the invention.

FIG. 2 is a cross-sectional view of the FIG. 1 panel along lines A-A.

FIG. 3A is a schematic view of a pre-cast edge according to an example embodiment of the invention.

FIG. 3B is a partial schematic view of a panel fabrication process according to an example embodiment of the invention.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

One aspect of the invention provides a prefabricated building panel. The prefabricated building panel may comprise an insulative core. At least one surface of the insulative core may be covered with a cementitious layer. An insulative casing may at least partially surround one or more edge surfaces of the panel. The insulative casing may increase a thermal break between components of the panel. In some embodiments the insulative casing also increases structural strength of the panel.

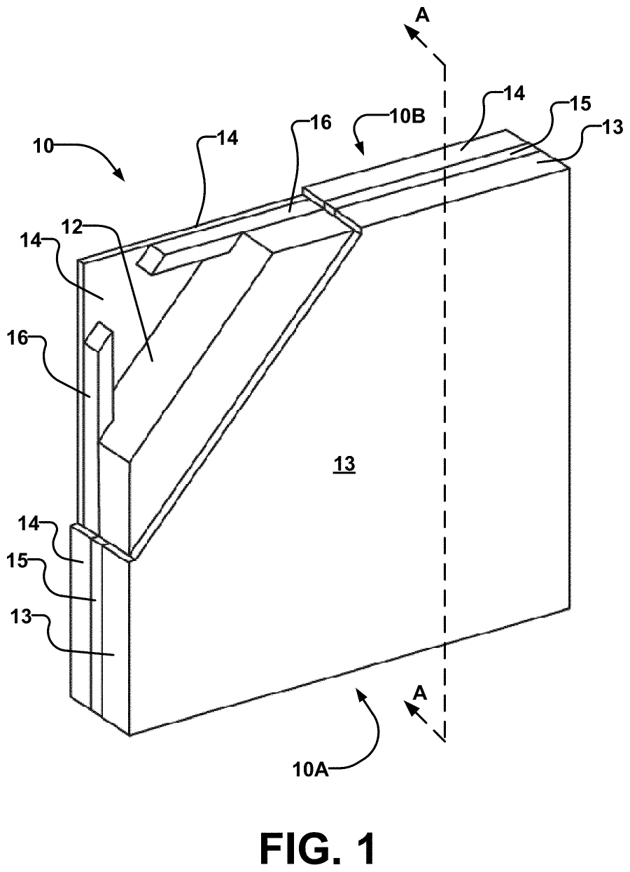

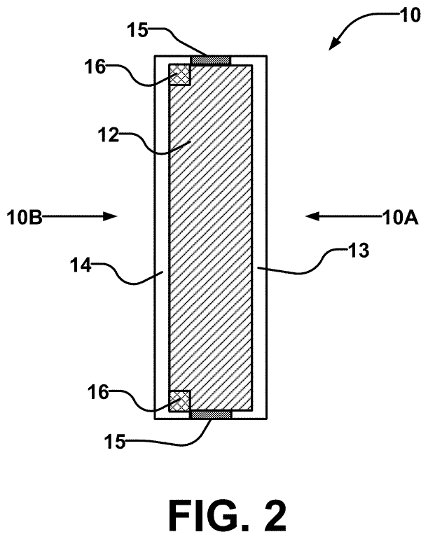

FIG. 1 is a schematic cutaway perspective view of an example panel 10 according to an embodiment of the invention. Panel 10 has opposing faces 10A and 10B. A set of panels 10 may be used to construct a building, to insulate an existing building and/or the like. Preferably panels 10 are plant finished (e.g. fully manufactured at a factory). Panels 10 may preferably be easily and quickly shipped to a construction site (e.g. on a flatbed truck, within shipping containers, on railway cars, etc.). Panels 10 may, for example, comprise wall panels, roof panels, floor panels, foundation panels, etc. Once panels 10 arrive at the construction site they may be easily and quickly assembled together. FIG. 2 is a cross-sectional view of panel 10 along the plane formed by line A-A of FIG. 1.

Panel 10 comprises an insulative core 12. Insulative core 12 provides thermal insulation for panel 10. Insulative core 12 may also at least partially structurally support panel 10. Insulative core 12 may also at least partially dampen sound transmission through panel 10. Insulative core 12 preferably comprises a single piece of insulation. However, this is not necessary. In some embodiments insulative core 12 is made of two or more pieces of insulation.

Cementitious layers 13 and 14 cover surfaces of insulative core 12 of example panel 10. Cementitious layer 13 corresponds to face 10A of panel 10. Cementitious layer 14 corresponds to face 10B of panel 10. Cementitious layers 13 and 14 are coupled to insulative core 12. In some embodiments cementitious layers 13 and 14 are wet-bonded to the surfaces of insulative core 12 (e.g. the cementitious layers “self-adhere” to the faces of insulative core 12). The “wet-bonding” may provide an adhesive chemical bond directly between two surfaces that are to be coupled together (e.g. a face of the insulative core and a cementitious layer).

Cementitious layers 13 and 14 have been shown in FIG. 1 as wrapping over edge surfaces of panel 10. However this is not necessary in all cases. In some embodiments one or both of cementitious layers 13 and 14 are flush with the edge surfaces of insulative core 12 (e.g. cementitious layers 13 and 14 do not partially cover the edge surfaces). In some embodiments one or both of cementitious layers 13 and 14 do not cover all of face 10A or 10B respectively. Cementitious layers 13 and 14 may cover the same or a different amount of surface area of insulative core 12.

An insulative casing 15 may surround one or more edge surfaces of insulative core 12. Insulative casing 15 may comprise an insulative material (e.g. Conrock™, rock wool insulation, etc.). Insulative casing 15 may advantageously increase the insulative strength of the thermal break between faces 10A and 10B of panel 10 that is provided by insulative core 12 (e.g. insulative casing 15 may increase the insulative strength of the thermal break provided between cementitious layers 13 and 14).

In some embodiments, insulative casing 15 also increases the structural strength of panel 10. In some such embodiments, insulative casing 15 comprises a higher-density material. In some embodiments insulative casing 15 comprises a material having a higher density than one or both of cementitious layers 13 and 14. In some embodiments insulative casing 15 comprises fiberglass, rubber and/or the like.

Additionally, or alternatively, the insulative strength of the thermal break between faces 10A and 10B of panel 10 may be strengthened by increasing an amount by which insulative core 12 extends beyond cementitious layer 13 and/or 14 (e.g. edges of cementitious layer 13 and/or 14 are not flush with edges of insulative core 12).

In currently preferred embodiments insulative casing 15 is coupled to the edge surfaces of insulative core 12 and/or cementitious layers 13 and 14 in a manner that does not lower the insulative strength of the thermal break between faces 10A and 10B (or between cementitious layers 13 and 14) of panel 10 (e.g. coupling insulative casing 15 to panel 10 does not create a thermal bridge in currently preferred embodiments). For example, insulative casing 15 may be bonded, adhered, etc. to other components of panel 10. In some embodiments insulative casing 15 is at least partially wet-bonded to one or both of cementitious layers 13 and 14. In some embodiments insulative casing 15 is physically coupled to panel 10 using one or more reinforcing members such as a structural mesh, doweling and/or the like. Typically such reinforcing members are not (or are bad) thermal conductors. In some embodiments such reinforcing members comprise fiberglass mesh, carbon fiber mesh, fiberglass rebar and/or the like.

In some embodiments one or both of cementitious layers 13 and 14 comprise reinforcing members. In some such embodiments the reinforcing members may be wrapped over one or more edge surfaces of panel 10. Insulative casing 15 may, for example, be coupled to panel 10 using such reinforcing members (e.g. insulative casing 15 is cast over such reinforcing members, etc.).

Although preferable in current embodiments it may not always be the case that insulative casing 15 may be coupled without lowering the strength of the thermal break provided by insulative casing 15. In some embodiments the coupling of insulative casing 15 to panel 10 marginally lowers the insulative strength of the thermal break provided by casing 15. In some embodiments the coupling lowers the insulative strength of the thermal break provided by insulative casing 15 by at most 5%. In some embodiments the coupling lowers the insulative strength of the thermal break provided by insulative casing 15 by at most 1%.

Insulative casing 15 may, for example, be made of rubber, rigid rock wool, foamed concrete, fiberglass, ceramic, PVC plastic, expanding foam, soft wood (e.g. around windows as a nailing board, etc.), a structural thermal break material (e.g. Armatherm™, etc.), and/or the like. In some embodiments insulative casing 15 is made using a pultrusion process. In some embodiments insulative casing 15 is molded into a desired shape. Additionally, or alternatively, insulative casing 15 may be (non-limiting):
cast;
sprayed (e.g. into a desired shape, into a desired recess to be filled, etc.);
applied in liquid form;
bent into shape;
cut into suitable sizes for a panel 10;
etc.

In some embodiments insulative casing 15 may have a higher insulative R-value than insulative core 12. However this is not mandatory in all cases. In some embodiments insulative casing 15 has an insulative R-value that is substantially the same as the insulative R-value of insulative core 12. In some embodiments insulative casing 15 has an insulative R-value that is less than the insulative R-value of insulative core 12.

In some embodiments outer surface portions of insulative casing 15 are moisture resistant. In some embodiments insulative casing 15 is made of a moisture resistant material. Additionally, or alternatively, moisture resistance of insulative casing 15 may be increased. For example, the outer surface portions of insulative casing 15 may be coated with a moisture resistant coating. Additionally, or alternatively, insulative casing 15 may be shaped to direct moisture along a designed path. For example, insulative casing 15 may be shaped (e.g. have a slope, dual mirroring slopes meeting at a centerline of panel 10, etc.) to direct moisture away from a core of panel 10 towards face 10A and/or 10B. As another example, insulative casing 15 may be sloped towards an exterior of a building (e.g. portions of insulative casing 15 which cover top edges of panels 10, windowsills, etc.) to drain water off the edge.

Insulative casing 15 may additionally protect components of panel 10. For example, casing 15 may dampen forces, vibrations, shocks, etc. that may be exerted onto edge surfaces of panel 10. This may protect the insulative core 12, cementitious layers 13 and/or 14, the interfaces between cementitious layers 13 and/or 14 and insulative core 12, etc. As another example, insulative casing 15 may provide a barrier against pests (e.g. insects, rodents, snakes, etc.) gaining entry into a core of panel 10.

Although insulative casing 15 has been illustrated in FIG. 1 as surrounding all four edge surfaces of panel 10 (e.g. top, bottom, left and right edge surfaces) this is not necessary in all cases. In some embodiments insulative casing 15 only surrounds one edge surface. In some embodiments insulative casing 15 surrounds a majority of the edge surfaces. In some embodiments insulative casing 15 surrounds like edge surfaces (e.g. left and right edge surfaces, top and bottom edge surfaces, etc.). In some embodiments insulative casing 15 only surrounds surfaces requiring a higher strength (insulative and/or structural strength) thermal break.

In some embodiments insulative casing 15 only partially surrounds an edge surface (e.g. insulative casing 15 does not cover an entire surface area of the edge surface).

Additionally, portions of insulative casing 15 which surround different edge surfaces may be the same or different. For example, different portions of insulative casing 15 may differ in (non-limiting):
materials used to make up the different portions;
thickness;
coupling techniques (e.g. how the different portions are coupled to a panel 10);
cross-sections (e.g. different portions may be shaped to direct moisture along different paths, etc.);
insulative R-value;
etc.

In some embodiments panel 10 comprises an opening for receiving a window, door, etc. In such embodiments an insulative casing as described elsewhere herein may surround one or more edge surfaces of panel 10 which define the opening. Preferably, such insulative casing extends along all of the edge surfaces which define the opening. Panel 10 may comprise such insulative casing alone or in addition to insulative casing 15. Such insulative casing may, for example (non-limiting):
increase the structural strength of the panel around the opening;
increase the insulative strength of the thermal break around the opening;
provide a decorative trim around the opening;
comprise features (e.g. protrusions, recesses, shims, etc.) for positioning and/or securing a window, door, etc. within the opening;
provide a moisture resistant barrier around the opening;
protect components of panel 10 (e.g. insulative core 12; cementitious layers 13, 14; etc.);
be dimensioned to receive a specific window, door, etc.
etc.

Panel 10 may comprise at least one connector. The connector may facilitate coupling of the panel to a building, coupling of the panel to other panels, maneuvering of the panel during construction (e.g. provides an attachment point for a hoist, etc.), etc. Additionally, or alternatively, panel 10 may comprise a structural frame (see e.g. structural frame 16 in FIG. 1). The structural frame may increase the structural strength of the panel. In such embodiments insulative casing 15 may, for example (non-limiting):
cover an interface formed between the connector and/or structural frame and other components of panel 10;
provide a thermal break between the connector and/or structural frame and other components of panel 10 (e.g. cementitious layers 13, 14; insulative core 12; etc.);
cover the connector and/or structural frame with a first insulative casing and cover other components of panel 10 with a second insulative casing having different properties than the first casing (e.g. different material, different thickness, etc.);
etc.

In some embodiments the connector comprises at least one aperture for receiving a connecting element (i.e. an element used to couple the connector to another component of the structure under construction). In some embodiments the connector comprises a cavity through which the connecting element may be accessed (e.g. to couple a nut to the end of the connecting element). In some embodiments the connector is a hollow steel element (e.g. a hollow rectangular steel section). In some embodiments the connector is like the connector(s) described in U.S. Patent Application No. 63/003,401 filed 1 Apr. 2020 and entitled SYSTEMS AND METHODS FOR COUPLING PREFABRICATED PANELS TOGETHER, which is hereby incorporated by reference for all purposes.

Additionally, or alternatively, panel 10 may comprise one or more structural elements such as, studs, braces, beams, etc. which extend through insulative core 12. Such structural elements may increase a structural strength of panel 10.

In some embodiments panel 10 comprises utility and/or service lines running through panel 10 such as electrical lines, plumbing, HVAC ducting, gas lines, central vacuum lines, etc. The utility and/or service lines may be interconnected between panels and thereby may extend beyond an insulative casing 15 of a panel 10. In some embodiments insulative casing 15 provides a thermal break at an interface formed between the utility and/or service lines and insulative core 12 and/or cementitious layers 13, 14.

Insulative core 12 may be made of rigid foam insulation. In some embodiments insulative core 12 is made of expanded polystyrene (EPS), polyisocyanurate (polyiso), extruded polystyrene (XPS) and/or the like. In some embodiments insulative core 12 is made of mineral fiber rigid insulation. In some embodiments insulative core 12 is at least 3 inches thick. In some embodiments insulative core 12 is between 3 and 24 inches thick.

Insulative core 12 typically has an insulative R-value of about R4 per inch. In some embodiments insulative core 12 has an insulative R-value of at least R12. In some embodiments insulative core 12 has an insulative R-value of at least R96. In some embodiments insulative core 12 has an insulative R-value between R12 and R96.

Cementitious layers 13 and 14 may be made of the same or different cementitious materials. In some embodiments at least one cementitious material has a density in the range of 5 to 35 MPA. In some embodiments at least one cementitious material has a density in the range of 35 to 90 MPA. In some embodiments at least one cementitious material has a density in the range of 90 to 200 MPA.

Although panel 10 has been shown as comprising two cementitious layers (e.g. cementitious layers 13 and 14) insulative casing 15 may be applied to other panels. The other panels may not necessarily comprise two cementitious layers. The other panels may comprise at least one interface between a cementitious layer made of a cementitious material and an insulative core (e.g. panels having a single cementitious layer, panels having at least one cementitious layer which partially extends over an edge surface of panel 10, etc.).

Insulative casing 15 may be positioned anywhere along edge surfaces of panel 10. In some embodiments insulative casing 15 is closer to face 10A than face 10B. In some embodiments insulative casing 15 is closer to face 10B than face 10A. In some embodiments insulative casing 15 is centered relative to both faces 10A and 10B.

Insulative casing 15 may have a thickness that is the same as or different than the thickness of cementitious layers 13 and/or 14.

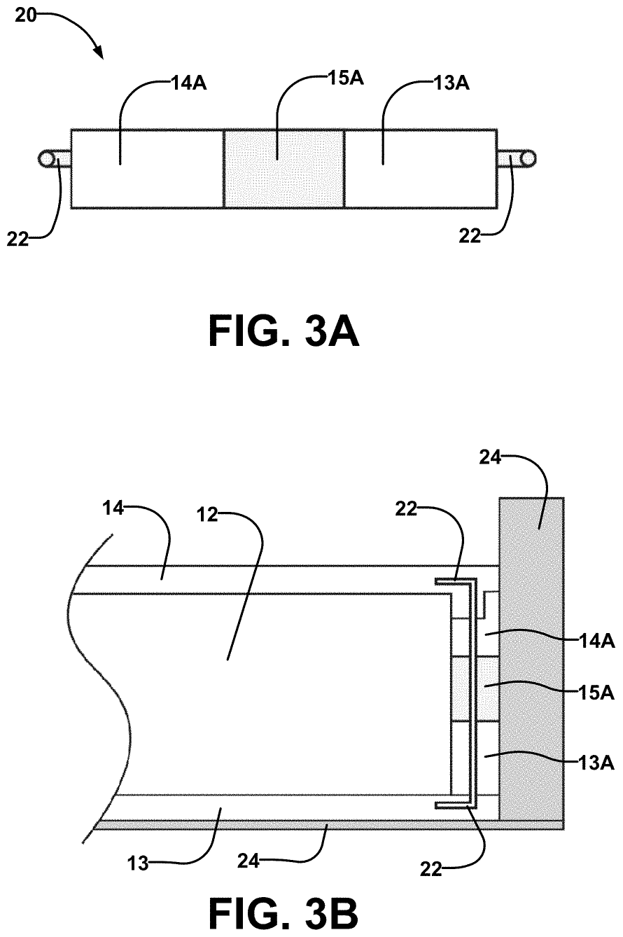

In some embodiments edges of panel 10 may be pre-cast. An example pre-cast edge 20 is schematically shown in FIG. 3A. Example pre-cast edge 20 comprises an insulative casing 15A between cementitious portions 13A and 14A. Insulative casing 15A provides a thermal break between cementitious portions 13A and 14A. Insulative casing 15A may be like insulative casing 15 described elsewhere herein. Cementitious portions 13A and 14A may be like cementitious layers 13 and 14 respectively described elsewhere herein.

An anchoring member 22 may be embedded within each of cementitious portions 13A and 14A. Anchoring member(s) 22 may be used to couple pre-cast edge 20 to panel 10. For example, anchoring member 22 on each side of pre-cast edge 20 may be embedded within the respective cementitious layer. An anchoring member 22 embedded within cementitious portion 13A may be embedded within cementitious layer 13 (e.g. cementitious layer 13 may be cast over anchoring member 22 or anchoring member 22 may be placed within a wet cementitious layer 13). Likewise, an anchoring member 22 embedded within cementitious portion 14A may be embedded within cementitious layer 14 (e.g. cementitious layer 14 may be cast over anchoring member 22 or anchoring member 22 may be placed within a wet cementitious layer 14).

In some embodiments an anchoring member 22 is embedded within each of cementitious portions 13A and 14A. In some embodiments a single anchoring member 22 extends across an entire width of pre-cast edge 20 (e.g. a single anchoring member 22 is embedded within cementitious portions 13A, 14A and insulative casing 15A).

In some embodiments anchoring member 22 couples insulative casing 15A to one or both of cementitious portions 13A and 14A. In some embodiments insulative casing 15A is bonded, adhered, etc. to cementitious portions 13A and 14A.

By pre-casting edges of panel 10, fabrication of panel 10 may advantageously be expedited. For example, pre-casting edges of panel 10 eliminates the need to cast each layer of the edges individually.

FIG. 3B schematically illustrates a portion of an example casting process. For example, a form 24 may be assembled. A first cementitious layer (e.g. cementitious layer 13) may be poured into form 24. Insulative core 12 and pre-cast edge 20 may be placed over the first cementitious layer. A second cementitious layer may then be poured over insulative core 12 and pre-cast edge 20.

Although pre-cast edge 20 has been shown as comprising both a cementitious portion 13A and a cementitious portion 14A, this is not mandatory in all cases. Pre-cast edge 20 may comprise a number of cementitious portions which corresponds to the number of cementitious layers of panel 10.

In some embodiments a pre-cast edge 20 may form one or more edge surfaces which surround openings in panel 10 (e.g. an opening for a window, an opening for a door, etc.). In some embodiments pre-cast edge 20 comprises one or more architectural features such as a drip edge, a sloping sill, design details (e.g. molding details, etc.) and/or the like.

### INTERPRETATION OF TERMS

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A prefabricated building panel, the panel comprising:
an insulative core having first and second opposing faces;
a first cementitious layer covering the first face of the insulative core and wrapping over the first face of the insulative core to cover a portion of at least one edge surface of the insulative core;
a second cementitious layer covering the second face of the insulative core and wrapping over the second face of the insulative core to cover a portion of the at least one edge surface of the insulative core; and
an insulative casing positioned between the first and second cementitious layers, the insulative casing covering the remaining portions of the at least one edge surface.

2. The panel of claim 1 wherein the insulative casing increases an insulative strength of a thermal break between the first and second cementitious layers.

3. The panel of claim 1 wherein the insulative casing increases structural strength of the panel.

4. The panel of claim 1 wherein the insulative casing covers at least a portion of two edge surfaces of the insulative core.

5. The panel of claim 1 wherein the insulative casing peripherally surrounds the insulative core.

6. The panel of claim 1 wherein the insulative casing has a thickness that is the same as the thickness of one or both of the first and second cementitious layers.

7. The panel of claim 1 wherein the insulative casing has a thickness that is different than the thickness of one or both of the first and second cementitious layers.

8. The panel of claim 1 wherein the insulative casing comprises at least one of rigid rock wool, foamed concrete, fiberglass, rubber, ceramic, PVC plastic, expanding foam, wood and a structural thermal break material.

9. The panel of claim 1 further comprising at least one pre-cast edge.

10. The panel of claim 9 wherein the pre-cast edge comprises:
a first cementitious portion;
a second cementitious portion;
an insulative casing portion between the first and second cementitious portions; and
at least one anchoring member, the at least one anchoring member configured to couple the pre-cast edge to the panel.

11. The panel of claim 10 wherein the at least one anchoring member extends through the first cementitious portion, the insulative casing portion and the second cementitious portion.

12. The panel of claim 10 wherein a first anchoring member is embedded within the first cementitious portion and a second anchoring member is embedded within the second cementitious portion.

13. The panel of claim 10 wherein the first cementitious portion comprises a cementitious material that is identical to a cementitious material of the first cementitious layer.

14. The panel of claim 10 wherein the second cementitious portion comprises a cementitious material that is identical to a cementitious material of the second cementitious layer.

15. The panel of claim 1 wherein the first and second cementitious layers comprise identical cementitious materials.

16. The panel of claim 1 wherein the first and second cementitious layers comprise different cementitious materials.

17. A method for fabricating a prefabricated panel, the method comprising:
pouring a first cementitious layer;
placing an insulative core and at least one pre-cast edge piece over the first cementitious layer; and
pouring a second cementitious layer over the insulative core and the at least one pre-cast edge piece;
wherein the at least one pre-cast edge piece comprises:
a first cementitious portion;
a second cementitious portion;
an insulative casing portion between the first and second cementitious portions; and
at least one anchoring member, the at least one anchoring member configured to couple the pre-cast edge to the panel.

18. The method of claim 17 wherein the at least one anchoring member is embedded within one or both of the first and second cementitious layers.

19. The method of claim 17 wherein the first cementitious layer and the first cementitious portion of the pre-cast edge comprise an identical cementitious material.

20. The method of claim 19 comprising positioning the first cementitious portion adjacent the first cementitious layer.

21. The method of claim 17 wherein the second cementitious layer and the second cementitious portion of the pre-cast edge comprise an identical cementitious material.

22. The method of claim 17 comprising positioning at least two precast edges around edges of the insulative core.

23. The method of claim 22 comprising positioning precast edges around all of the edges of the insulative core.

24. A prefabricated building panel, the panel comprising:
an insulative core having first and second opposing faces;
a first cementitious layer covering the first face of the insulative core; and
an insulative casing at least partially covering at least one edge surface of the insulative core.
